(19) United States
(12) Patent Application Publication
(10) Pub. No.: US 2017/0265478 A1
(43) Pub. Date: Sep. 21, 2017

(54) Lysozyme-Based Plant-Protective Compositions

(71) Applicant: Innovative Organics Patent Holdco, LLC, Loveland, CO (US)

(72) Inventor: Victor H. Restrepo, Denver, CO (US)

(21) Appl. No.: 15/073,587

(22) Filed: Mar. 17, 2016

(51) Int. Cl. A01N 63/00; A01N 37/44; A01N 65/24; A01N 25/30

(52) U.S. Cl. CPC A01N 63/00; A01N 25/30; A01N 37/44; A01N 65/24; C12Y 302/01017; C12Y 304/21

(57) ABSTRACT

Plant-protective compositions comprising lysozyme and methods of their use are provided. Lysozyme is a naturally-derived material forming a desirable non-toxic barrier that eliminates various plant pests and may promoting plant growth. Formulations are provided, which may include carriers, inert ingredients and formulation components, and/or active ingredients. Methods of protecting a plant, plant part, seed, or site where plants are to be grown from a pest using the compositions are also provided. Exemplary plants include those of the Cannabis genus.

### FIELD OF THE INVENTION

The disclosure relates generally to the field of plant-protective compositions containing lysozyme and methods of their use in preventing and treating plant parasites.

### BACKGROUND

Plant infestation by parasites, e.g. fungus and small arthropods such as mites, causes severe injury to plants. For example, mites feed on plant foliage by creating microscopic holes on the plant surface. This results in moisture loss and eventually leads to plant dehydration and reduced photosynthetic and repair functions. If untreated, plant death can occur rapidly. Both indoor and outdoor crops are vulnerable to mite infestation. Even when overall plant yields are not reduced by parasite infestation, agricultural products suffering from parasite infestation are less desirable and in many cases cannot be sold.

Conventional treatments for parasite infestation vary based on the specific crop. In the case of products meant for human consumption, health and safety concerns and market pressure limit treatment options. For example, highly effective neem oil has been associated with infertility, birth defects, and liver damage. Other treatments include insecticidal soaps and detergents, which may contribute to undesirable flavors when an agricultural product is consumed, e.g. eaten or combusted for inhalation.

### SUMMARY

Plant-protective compositions comprising lysozyme are provided. Lysozyme-containing formulations may contain one or more of carriers, inert ingredients, and active ingredients. Methods of applying the compositions are also provided. The compositions may be applied to a plant, plant part, seed, or site where plants are to be grown, and may target pests such as mites, mildew, and mold. Because lysozyme is a naturally-derived material, the compositions may be non-toxic and environmentally friendly, making them suitable for application to plants intended for human consumption or plants grown where the use of pesticides may pose a threat to human health. Exemplary plants include those of the Cannabis genus.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### DETAILED DESCRIPTION

Plant-protective compositions comprising lysozyme are provided. Lysozyme may have a number of benefits in treating pests and other plant ailments. The compositions may be non-toxic and result in little change in plant appearance or odor, and may be an effective pest treatment suitable for use on plants to be consumed by humans. The compositions may contain carriers, for example water. The compositions may contain inert ingredients, for example surfactants. The compositions may contain active ingredients, for example pesticides. Method of using such compositions are provided. The compositions may be applied to plants, plant parts, seeds, or a site where plants are to be grown. Applying the compositions may protect the plant from a pest, for example mites, mildew, or mold. The compositions may also have other adjuvant properties.

Lysozyme is an enzyme derived from various natural sources, and has been used in many industries to control bacterial and fungal growth. The natural enzymatic function of lysozyme is hydrolyzing the β(1-4) glycosidic bond between residues of N-acetylmuramic acid and N-acetylglucosamine in certain polysaccharides, such as those found in the cell walls of some bacteria. Humans and other animals produce forms of lysozyme, which contributes to the antibacterial effects of mucus. Currently, commercial sources use concentration of the lysozyme found in chicken egg whites.

Lysozyme was discovered by Alexander Fleming (penicillin discoverer) for use as a medical antibiotic, when he tested saliva in an attempt to identify new antibacterial agents. Lysozyme has multiple modes of action against bacteria and fungi, with its action attributed to both bacterial cell wall lysing and the formation of a mucus-like covering that impairs fungal respiration and metabolism. However, the medical usefulness of lysozyme is limited due to its gel-like form that makes it unsuitable for non-topical uses, such as use as a systemic antibiotic agent.

Modern uses of lysozyme are mostly limited to the dairy industry and the post-harvest preservation of harvested fruit. Because lysozyme is naturally produced in humans and is human animal lysozymes are non-toxic when ingested, their use is particularly favorable where the product is intended for broad agricultural use and eventual human consumption.

### Lysozyme-Containing Formulations

The formulations disclosed herein comprise lysozyme. Lysozyme compositions disclosed herein have been developed to combat a number of pests and pathogens. Specifically, the compositions may be effective against plant pathogens and pests that include but are not limited to bacteria and fungus. The compositions may allow improved eradication of other common pests such as very small insects and arachnids, including but not limited to mite species, and also may combat bacteria and fungus. The fungus may be a phytopathogenic fungus.

“Lysozyme” as used herein refers to one or more of the glycoside hydrolases that are characterized by their action of catalyzing hydrolysis of 1,4-beta linkages between N-acetylmuramic acid and N-acetyl-D-glucosamine residues in peptidoglycan and between N-acetyl-D-glucosamine residues in chitodextrins. Numerous truncated, substituted, mutated, or orthologous lysozymes may retain this activity, and their use is specifically contemplated herein. Because lysozyme is highly conserved across species, use of any lysozyme is expressly contemplated herein. In some embodiments, the lysozyme is human lysozyme. In other embodiments, the lysozyme is a chicken egg white or albumin lysozyme. In another embodiment, the lysozyme may be an invertebrate lysozyme, such as a crustacean lysozyme. Other useful sources of lysozyme may include those generated in natural or genetically modified bacteria. Formulations disclosed herein may incorporate lysozymes of varying origins, compositions, and concentrations.

Lysozyme composition varies by manufacturer and supplier. The lysozyme may be a substantially pure microcrystalline lysozyme. Dry and microcrystalline lysozyme may become solubilized by a carrier or formulation additive. The lysozyme may be a wetted or aqueous lysozyme. When wetted or aqueous lysozyme is used, the water content may be taken into account in calculating the formulation ratios. In a specific embodiment, a 100% pure, natural crystalline lysozyme may used. Such lysozymes are typically used in cheese manufacture, and may be sourced from a variety of manufacturers.

The mode of action of the disclosed lysozyme-containing formulations in fighting small insects and arachnids, including mite species, is to surround and entomb pests of a small size. Pests are unable to escape lysozyme entrapment, and rapidly starve or are unable to respire. This effect has not previously been explored in the treatment of such pests on agricultural plants. “Pests” as used herein may refer to a number of organisms that negatively impact one or more aspects of plant development, cultivation, viability, heartiness, or productivity. Exemplary pests include small insect pests such as mites and arachnids. In some embodiments, the pest is a spider mite. In other embodiments, the pest is a russet mite.

Other plant pathogens that the compositions may treat include bacteria and fungus. Lysozyme-containing compositions may form a permeable membrane. The membrane may function as a biological quarantine that treats and prevents the spread of pathogens, i.e. bacteria and fungus.

In some embodiments the compositions may contain up to 25% lysozyme by weight. The composition may comprise between 0.01 and 25% lysozyme by weight. The composition may comprise between 2% and 25% of the composition by weight. The composition may comprise between 5% and 25% of the composition by weight.

In some embodiments, formulations comprise a carrier. “Carrier” as used herein refers to an inert formulation ingredient that aids in the delivery of the lysozyme. Such carriers may be solid or liquid. In some embodiments, the carrier is a solvent. In a specific embodiment, the carrier may be water. Water may be a suitable carrier because is considered safe for human consumption and has an acceptable drying time. In some embodiments, the carrier may evaporate when deposited on a target surface, which may increase the viscosity or concentration of lysozyme. It is specifically contemplated that various carriers are suitable for use in the formulations disclosed herein. In some embodiments, carrier selection may be based on the need for lengthened or shortened drying time. In other embodiments, the carrier selection may be based on plant characteristics, such as optimal humidity or chemical or physical sensitivity.

The carrier may make up the remainder of any formulation. The compositions may comprise up to 95% carrier by weight. The compositions may comprise between 0.01% and 95% carrier by weight. The compositions may comprise between 0.01% and 90% carrier by weight. The compositions may comprise between 25% and 95% carrier by weight. The compositions may comprise between 50% and 95% carrier by weight. The compositions may comprise between 75% and 95% carrier by weight. The compositions may comprise between 80% and 90% carrier by weight.

The formulations may comprise one or more inert ingredients. In some embodiments, the inert ingredient may comprise a surfactant. “Surfactant” as used herein refer to formulation additives and compounds that lower the surface (interfacial) tension between a liquid and either a liquid or solid. The surfactant may act as a detergent, wetting agent, emulsifier, foaming agent, and/or dispersant. The surfactant may be amphiphilic, and may be soaps, linear alkylbenzenesulfonates, lignin sulfonates, fatty alcohol ethoxylates, alkylphenol ethoxylates, and the like. In some embodiments, the surfactant may be aloe vera. Aloe vera may thicken a formulation as well as contain surfactants including but not limited to saponins. In other embodiments, the surfactant may be a polysorbate, such as polysorbate 20. In still other embodiments, Yucca extract may be used as a surfactant.

Surfactants may be emulsifiers, which may act to either produce or stabilize an emulsion. Aloe vera may also serve as an emulsifier. Aloe vera may be nontoxic and food safe, making its use desirable where the compositions may eventually be eaten or consumed. Surfactants may improve the ability of the compositions to adhere to foliage and pests.

Other inert ingredients may include pH stabilizers and other agents. For example, biochar may be added as a buffer.

In some embodiments, the inert ingredients comprise up to 10% of the formulation by weight. In some embodiments, the inert ingredients comprise less than 3% of the composition by weight, and may comprise approximately 2% of the composition by weight. It is expressly contemplated that “approximately” includes minor formulation variations. In one embodiment, aloe vera comprises up to 5% of the composition by weight. In other embodiments, aloe vera comprises between 1% and 3% of the composition by weight.

The formulations may comprise one or more active ingredients. “Active ingredients” as used herein refer to formulation ingredients having biological activity against plant pests or other undesirable plant, animal, or environmental factors. Active ingredients may have any mode of action, and may be synthetic, natural, or naturally-derived. Active ingredients may be selected from any suitable compound that has the desired activity against plant pests or other undesirable plant, animal, or environmental factors. In some embodiments, active ingredients may comprise one or more pesticides. The pesticide may be a biopesticide, or may be chemical pesticide. The pesticide may be a microbial pesticide. The microbial pesticide may be a lysine. In some embodiments, the pesticide comprises at least one fungicide. In other embodiments, the pesticide may be one or more of an herbicide, insecticide, acaricide or miticide, molluscicide, larvicide, or nematicide. The pesticide may comprise lactoferrin. The pesticide may comprise avocado seed extract and/or avocado oil.

In some embodiments, the plant-protective composition may comprise (a) between 2% and 25% lysozyme, (b) approximately 0-2% surfactant, and (c) balance water to equal 100%. In some embodiments, a formulation contains lysozyme at approximately 10% by weight. In some embodiments, a formulation contains surfactant at approximately 2% by weight. In one embodiment, the composition may comprise 25% lysozyme, approximately 2% surfactant, and remainder water. In some embodiments, the surfactant is aloe vera. In some embodiments, the lysozyme comprise a chicken egg lysozyme or albumin.

In some embodiments, the plant protective composition may comprise (a) between 2% and 25% lysozyme, (b) 0-2% surfactant, (c) 0-2% pesticide, and (d) balance water to equal 100%. In some embodiments a formulation contains lysozyme at approximately 10% by weight. In some embodiments, a formulation contains approximately 2% of a pesticide. In some embodiments the pesticide is a lysine. The pesticide may comprise lactoferrin. In some embodiments, the plant protective composition may comprise (a) between 2% and 25% lysozyme, (b) between 0% and 2% surfactant, (c) up to 5% avocado seed extract, and (d) balance water to equal 100%. The composition may comprise approximately 2% surfactant.

Methods of plant protection

Methods of plant protection comprising applying lysozyme-containing compositions as are provided. In some embodiments, methods of improving plant health are provided. In some aspects, methods of controlling one or more plant diseases are provided.

In some aspects, methods for treating pests on a plant are provided. In some aspects, compositions are applied to a plant, plant part, seed or other propagation material, or site where plants are to be grown. Application of the compositions may protect against pests. Application of lysozyme-containing compositions may cause immobilization and death of certain pests such as invertebrates and insects. In some embodiments, the pests are selected from mites, mildew and mold. The pest may be a spider mite. The pest may be a russet mite. Other bacteria and fungi may also be treated.

In some aspects, compositions may be used to prevent the spread of a pest or parasite. In some embodiments, the pest or parasite is prevented from spreading on one plant. In other embodiments, pests or parasites are prevented from spreading between plants. For example, plant clones typically show high susceptibility to infestation, which may be due to their biological similarity. Indoor growing methods may amplify these problems. Indoor growing methods also amplify the difficulties in using traditional pesticides. Application of compositions to plant clones may provide a quarantine and may prevent the spread of pests and parasites. Application may also allow clones to be transported more safely or introduced to new growth environments, e.g. a greenhouse, without threatening other plants. In one embodiment, Cannabis clones are treated.

In some embodiments, plants or plant parts are treated with compositions immediately before or after harvest. In some embodiments, such pre-harvest or post-harvest treatment may provide a quarantine and may prevent the spread of pests and parasites. In one embodiment, fruits or vegetables are treated. In other embodiments, Cannabis clones are treated.

Exemplary plants that compositions may be applied to include but are not limited to: cultivated plants, such as cereals, e.g. wheat, rye, barley, triticale, oats or rice; beets; fruits, such as pomes, stone fruits or soft fruits, e.g. apples, pears, plums, peaches, almonds, cherries, strawberries, raspberries, blackberries or gooseberries; leguminous plants, such as lentils, peas, alfalfa or soybeans; oil plants, such as rape, mustard, olives, sunflowers, coconut, cocoa beans, castor oil plants, oil palms, ground nuts or soybeans; cucurbits, such as squashes, cucumber or melons; fiber plants, such as cotton, flax, hemp or jute; citrus fruit; vegetables, e.g. lettuce; lauraceous plants, energy and raw material plants; and the like. Plants may be genetically modified or unmodified.

The formulations and compositions may be applied in any manner. In some embodiments, the compositions may applied by spraying or atomizing. In other embodiments, the compositions may be applied by rubbing, painting, dripping, etc. The formulations may be rinsed off immediately, may be rinsed off after a period of time, or may not be rinsed off at all. In some embodiments, the formulations are sprayed and allowed to sit for approximately 30 minutes to two hours. In some embodiments, a formulation is applied once. In other embodiments, a formulation is applied multiple times. In some embodiments, 80% pest reduction (measured as immobilization) is observed within one hour. In some embodiments, 100% pest reduction is observed within three days.

Compositions may be applied with any suitable adjuvant or other agent. In some embodiments, compositions may further be mixed with other formulations prior to application. In a specific embodiment, one or more pesticides or pesticidal compositions are mixed with a formulation prior to application.

The compositions may be applied to any plant. The plant may comprise an agricultural plant, such as a crop, a fruit, etc. In some embodiments, the plant comprises a flowering plant. In a specific embodiment, the plant comprises a Cannabis genus plant.

In one embodiment, a method for protecting a Cannabis genus plant, plant part, or seed against mites is provided. A composition of (a) 8-25% lysozyme, (b) 0-2% surfactant, (c) 0-2% pesticide, and (d) balance water to equal 100% may applied. In one embodiment, a composition of (a) 8-25% lysozyme, (b) approximately 2% surfactant, and balance water is applied.

Methods of using compositions in aqueous environments are provided. Compositions comprising lysozyme may be used in aqueous environments to eliminate plant pests and disease. Lysozyme compositions may be used where fish or other organisms are present. Fish and other aquatic organisms are typically sensitive to pesticides and other agents, resulting in the inability to use pesticide formulations in aqueous environments. Lysozyme compositions do not harm fish and other aquatic organisms, and may be used to treat pests and disease in an aqueous environment. In one embodiment, the aqueous environment is an aquaponics system.

### EXAMPLES

The following examples are provided to illustrate aspects of the invention, and in no instance should be considered to limit the scope of the claims.

### Example 1

### Formulation Preparation

A solution of 10% food-grade lysozyme powder and 90% distilled water (by weight) was created by whipping. Because the enzyme is somewhat hydrophobic at lower temperatures and high formulation percentages, the temperature was held above 65 degrees Fahrenheit. Because whipping incorporates a moderate volume of air, the formulation is allowed to stand for approximately 15-30 minutes prior to use for optimal effectiveness.

A solution of 10% food-grade lysozyme powder, 2% aloe vera surfactant, and 88% distilled water (by weight) was created by whipping.

### Example 2

### Formulation Tests on Mold and Mildew

Samples of black mold, powdery mildew, downy mildew, and spotted mildew were obtained. Each solution prepared above was sprayed onto each of the samples and allowed to rest, with sample evaluated under a microscope at regular intervals. All samples showed significant or complete destruction of cellular walls over a period of one hour. Further observation over three days determined the complete destruction of all viable mold and mildew in the samples. The surfactant-free formulation had increased effectiveness, while the surfactant-containing formulation had slightly reduced effectiveness, but slightly improved application.

### Example 3

### Formulation Tests on Mites

The surfactant and surfactant-free formulations were created as above. The solutions were sprayed onto samples of spider mites and russet mites, and the results were monitored. With respect to spider mites, the solution quickly dried into an encapsulation, immobilizing 100% of the contacted spider mites within one hour. With respect to russet mites, 80% of the contacted russet mites were encapsulated and immobilized within one hour, with 100% encapsulation and immobilization occurring at 105 minutes. Monitoring of the samples continued for three days, with 100% elimination of all mites confirmed over this time period. The surfactant-free formulation had increased effectiveness, while the surfactant-containing formulation had slightly reduced effectiveness, but slightly improved application.

### Example 4

### Formulation Tests on Plants

Solutions of (a) 5% food-grade lysozyme, 2% aloe vera, and 93% distilled water and (b) 5% food-grade lysozyme and 95% distilled water were sprayed on indoor-grown flowering cannabis plants infected with black mold, powdery mildew, downy mildew, and spotted mildew. The results were observed over three days. The cellular walls of all black mold, powdery mildew, downy mildew, and spotted mildew were destroyed within one hour, with further observation over three days showing the complete destruction of all viable mold and mildew in the samples. The surfactant-free formulation had increased effectiveness, while the surfactant-containing formulation had slightly reduced effectiveness, but slightly improved application.

The 5% food-grade lysozyme compositions were applied to indoor-grown flowering cannabis plants infected with spider mites and russet mites. These formulations were not significantly effective against spider mites and russet mites, and had almost no effect against russet mites.

Solutions of (a) 9-25% food-grade lysozyme, 2% aloe vera, and balance distilled water to equal 100% and (b) 9-25% food-grade lysozyme and balance distilled water to equal 100% were similarly tested on flowering cannabis plants, and had substantially the same high efficacy against all tested parasites (black mold, powdery mildew, downy mildew, spotted mildew, spider mites, and russet mites) as seen from Experiments 2-3. The surfactant-free formulation had increased effectiveness, while the surfactant-containing formulation had slightly reduced effectiveness, but slightly improved application.

Additional solutions having greater than 25% food-grade lysozyme had high viscosity, and were decreasingly effective as the lysozyme concentration was increased, tapering to no effectiveness at a 50% formulation.

Formulations comprising from 9-25% lysozyme are thus highly effective in the treatment of multiple plant pathogens. Formulations also had no observed phytotoxicity, no odor, and were easily washed off of the plant using water. Combustion did not reveal any additional odors. No other changes to flower morphology or quality were observed.

### Example 5

### Pre-Harvest and Post-Harvest Applications

Solutions according to Examples 1-4 were atomized onto samples of (1) healthy indoor-grown flowering cannabis plants immediately prior to harvesting; and (2) healthy indoor-grown flowering cannabis flower immediately after harvesting and prior to packaging for transport. Observation of group (1) over three days after harvesting verified elimination of tested parasites (black mold, powdery mildew, downy mildew, spotted mildew, spider mites, and russet mites). Observation of group (2) over three days after packaging verified elimination of tested parasites. Additional tests on harvested fruits identified similar results.

The preceding description is presented for purposes of illustration and description, and does not limit the scope of the invention to the disclosures, examples, and embodiments provided therein. On the contrary, a number of modifications and variations are possible based on the above teachings, and alternative embodiments are included to the full scope allowable by the prior art.

1. A plant-protective composition comprising lysozyme and carrier.

2. The plant-protective composition of claim 1, wherein the lysozyme comprises a chicken egg lysozyme.

3. The plant-protective composition of claim 1, wherein the carrier comprises a solvent.

4. The plant protective-composition of claim 1, wherein the carrier comprises water.

5. The plant-protective composition of claim 1, further comprising one or more inert ingredients.

6. The plant-protective composition of claim 5, wherein the inert ingredient comprises a surfactant.

7. The plant-protective composition of claim 6, wherein the surfactant comprises aloe vera.

8. The plant-protective composition of claim 1, further comprising one or more active ingredients.

9. The plant-protective composition of claim 8, wherein the active ingredient comprises a pesticide.

10. The plant-protective composition of claim 9, wherein the pesticide comprises at least one biopesticide.

11. The plant-protective composition of claim 10, wherein the biopesticide comprises a microbial pesticide.

12. The plant-protective composition of claim 11, wherein the microbial pesticide comprises a lysine.

13. The plant-protective composition of claim 9, wherein the pesticide comprises at least one fungicide.

14. The plant-protective composition of claim 9, wherein the pesticide comprises an insecticide, acaricide or miticide, molluscicide, larvicide, or nematicide.

15. The plant-protective composition of claim 14, wherein the pesticide comprises lactoferrin.

16. The plant-protective composition of claim 14, wherein the pesticide comprises avocado seed extract or avocado oil.

17. The plant-protective composition of claim 1, wherein the lysozyme comprises up to 25% of the composition by weight.

18. The plant-protective composition of claim 17, wherein the lysozyme comprises between 0.01% and 25% of the composition by weight.

19. The plant-protective composition of claim 17, wherein the lysozyme comprises between 2% and 25% of the composition by weight.

20. The plant-protective composition of claim 17, wherein the lysozyme comprises between 5% and 25% of the composition by weight.

21-154. (canceled)
